(19) United States
(12) Patent Application Publication
(10) Pub. No.: US 2011/0160902 A1
(43) Pub. Date: Jun. 30, 2011

(54) METHOD AND APPARATUS FOR PRODUCING CUSTOMIZED FOOD BLENDS FOR ANIMALS

(76) Inventor: Lucy Postins, San Diego, CA (US)

(21) Appl. No.: 12/980,327

(22) Filed: Dec. 28, 2010

Related U.S. Application Data
(60) Provisional application No. 61/290,477, filed on Dec. 28, 2009.

(51) Int. Cl. G05D 11/02; G06F 3/00; G06F 15/16; G05D 7/00

(52) U.S. Cl. 700/239; 708/132; 709/203; 700/240; 700/282

(57) ABSTRACT

A method and apparatus for producing customized food blends for animals includes a food assembler that is in electrical connection with one or more computer systems that provide instructions and specifications for the preparation of a custom food blend. The food assembler includes a number of basic food elements contained in hoppers that can be selectively combined to create a custom food blended from the basic food elements. These elements may include a selection of meats, fruits, vegetables, grains, herbs, vitamins, minerals, and other therapeutic elements.

### RELATED APPLICATIONS

This application claims the benefit of priority to U.S. Provisional Patent Application Ser. No. 61/290,477 by the same inventor for an invention entitled “Method and Apparatus for Producing Customized Food Blends for Animals”, filed Dec. 28, 2009, and currently co-pending.

### FIELD OF THE INVENTION

The present invention relates generally to pet foods. The present invention is more particularly, though not exclusively, related to the optimization of an animal's health through the proper combination of ingredients in its food.

### BACKGROUND OF THE. INVENTION

Along with the domestication of animals comes the need to provide for the animals' needs. These needs include love, shelter, exercise, water, and of course food. Food is one of the most basic needs of all animals; however, very few of the common and commercially available pet food products are wholesome, nutritious foods suitable for consumption by animals.

Instead of providing pets with chemical and preservative free foods, most food manufacturers typically include both chemicals and preservatives in their foods. In fact, a close review of the actual ingredients in animal foods reveals an astonishing list of items. For instance, according to the Association of American Feed Control Officials (“AAFCO”), guidelines allow for the incorporation of sick and diseased animal components in pet foods. In fact, the inclusion of dead, diseased, dying or disabled animals in pet food is acceptable under the AAFCO standards. Some of these animals might include animals that have been euthanized using sodium pentobarbital. Because sodium pentobarbital does not break down during the cooking process, the final pet food product may contain this very harmful chemical.

Based on the various chemicals, preservatives and disease that may be contained in commercially available pet foods, there is an increase in cancer and disease in animals that consume these foods. For instance, cancers including kidney, bladder, skin, stomach and spleen cancers show increased occurrences in pets that consume commercial pet foods. Also, there is a higher incidence of cell diseases such as leukemia, liver dysfunction, major organ failure, immune system compromise, and severe allergies. Birth defects, premature blindness, chronic diarrhea, poor digestion, and behavior problems are more common in animals that consume commercial pet foods.

Even in “high end” pet foods where excessive chemicals, preservatives and disease are supposedly avoided, the ingredients utilized are often inferior. For instance, the Canine Nutrition Expert (CNE) Subcommittee of the AAFCO has set forth basic nutritional requirements for pet foods. These basic requirements set only minimal standards for pet foods, and this allows pet food manufacturers to incorporate inferior protein in their foods which may consist of, but not be limited to, variations of the following: Wheat, Corn, Chicken by-products, Soy, Gluten. These ingredients are hard to digest and can cause health problems later on if used for a long period of time. These foods may also include processed sugar, which is another ingredient that should clearly be avoided. However, even commercially available “premium pet food” products often contain animal by-products, dried meat “digest,” or meat “meal.” These ingredients are a much cheaper alternative to quality nutritional sources.

When considering the necessary ingredients for a pet food, it is necessary to take into account the specifics of the pet itself. For instance, a puppy has very different nutritional needs than an older dog, and a pregnant and lactating dog has her specific needs too, but there is little consideration of other underlying factors that are specific to the animal as an individual. Despite these varying nutritional requirements, commercial pet foods generally have one or two “formulas” for their pet foods. These might include, for example, “Puppy”, “Adult”, and “Older Dog” versions of their basic food. Often times, the primary difference between these foods is not nutritional, rather, the difference is limited to the size and/or hardness of the kibble. As a result of the industries “one-food-fits-all” approach, specific nutritional needs are often overlooked. This is even more problematic when considering the individual preferences, allergies, or medical conditions of a specific pet.

In light of above, it would be advantageous to provide a method and apparatus for producing customized food blends for animals that allows for the consideration of the specific nutritional and health needs of the animal. It would also be advantageous to provide a method and apparatus for producing customized food blends for an animal that takes into consideration the specific physical requirements of a specific animal, such as age, illness, risk factors for disease, allergies, taste preferences, etc. It would also be advantageous to provide a method and apparatus for producing customized food blends for animals that is relatively easy to use, and relatively cost efficient.

### SUMMARY OF THE INVENTION

A method and apparatus for producing customized food blends for animals includes a food assembler that is in electrical connection with one or more computer systems that provide instructions and specifications for the preparation of a custom food blend. The food assembler includes a number of basic Food and Drug Administration (FDA) approved food elements contained in hoppers that can be selectively combined to create a custom food blended from the basic food elements. These high quality food elements may include a selection of meats, fruits, vegetables, grains, herbs, vitamins, minerals, and other therapeutic elements.

One embodiment of the method and apparatus for producing customized food blends for animals may include a kiosk accessible in a veterinary office, pet supply store, animal shelter, or anywhere localized production of pet food is advantageous. The kiosk includes a food assembler, and a user may access a terminal adjacent to or a part of the kiosk, to specify the contents of the pet food to be produced. The food is then produced by selectively incorporating predetermined quantities of the basic food elements into a final food product that is dispensed.

An alternative embodiment contemplates a food assembler separate from other remote users, such as a pet owner at home, or a veterinary clinic. These remote users may communicate with the food assembler via the Internet or other known communication methods to identify and select the various ingredients to be incorporated into the pet food. The user may also select the quantity of the food product to be produced (1 pound, 5 pound, etc.), and may specify a mailing destination or pickup location. The user then completes the transaction online, and either receives the custom food product on their doorstep, or picks it up at the local store where the food assembler is located.

A central server may be located adjacent the food assembler, or remotely and connected via a network connection or Internet. The central server may store customer data, animal standards such as nutritional requirements for the particular animal, and even preferences, allergies, and therapeutic requirements for the animals, such as Traditional Chinese Medicine, ayurvedic treatments, and the like. Users may access their stored data from the server for easy re-ordering, or for record keeping in cases when an animal's diet will be adjusted over time for optimization.

An online user interface is provided that allows a user to access a central server to input customer data, create custom recipes and order food blends. The online user interface may be specially equipped to provide guidance in recipe creation, menu selection, and provide information regarding specific recipe ingredients or blend suggestions. Also, the user interface may be customized for specific customers, such as new customers, returning customers, and professionals, such as veterinarians.

### DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a system level diagram of the apparatus for producing customized food blends for animals, including a stand-alone system having a food assembler having an assortment of food ingredient hoppers, and in communication with a kiosk terminal and printer, and a remotely located server that is in communication with the stand-alone system, and a number of remote user terminals in communication with the food assembler for remotely identifying and transmitting food specifications to the food assembler;

FIG. 2 is a top plan view of an exemplary digital storage media upon which the method for producing customized food blends for animals can be stored and transmitted;

FIG. 3 is a flow chart of the method and apparatus for producing customized food blends for animals including the identification of an existing customer, the selection of standard or custom food products, the determination and modification of ingredient contents, verification that nutritional requirements are met, and the payment, assembly and packaging of the custom food product;

FIG. 4 is a flow chart of the method for producing customized food blends for animals having additional selection criteria for incorporation of animal characteristics, health conditions, and verification that nutritional requirements are met, and the assembly and packaging of the custom food product;

FIGS. 5A and 5B is a flow chart of the method for producing customized food blends for animals providing for the selection of the animal breed, animal health condition, ayurvedic treatment selection, Chinese Medicine treatment selection, matching characteristics and health conditions to a predetermined recommendation and providing a recommended food content list, verification that food meets nutritional requirements, then the processing payment, assembly and dispensing of the food product;

FIG. 6 is a representative view of an exemplary customer data file of the present invention showing pertinent customer information, and information regarding that customer's animals, such as dog/cat, age, life stage, allergies, dislikes, etc.;

FIG. 7 is a representative view of an exemplary available ingredient list of the present invention showing the specific ingredients, the recommended minimum and maximum levels for each ingredient, and a selection cursor that may be positioned to identify specific quantities of each ingredient to be included in the assembled food product;

FIG. 8 is a representative view of an exemplary ayurvedic treatment list of the present invention showing the ayurvedic treatment list available, and the various elements, energies and doshas, from which specific food ingredients may be added into the formula to address specific ayurvedic treatment requirements;

FIG. 9 is a representative view of an exemplary Traditional Chinese Medicine treatment list of the present invention showing the five basic Chinese Medicine treatment areas, and the selection of elements, energetics and meridians that can be selected for incorporation into the formula to address specific Traditional Chinese Medicine treatment requirements;

FIG. 10 is a representative view of an exemplary label for the custom food product of the method and apparatus for producing customized food blends for animals, showing the pertinent customer information and pet identifier, an ingredient list, and the percentage of each ingredient in the final food product; and

FIG. 11 is a flow chart of the online user interface of the present invention showing the online creation of a user database, the inputting of user information, the creation of a recipe, and the online purchase and check-out.

### DETAILED DESCRIPTION

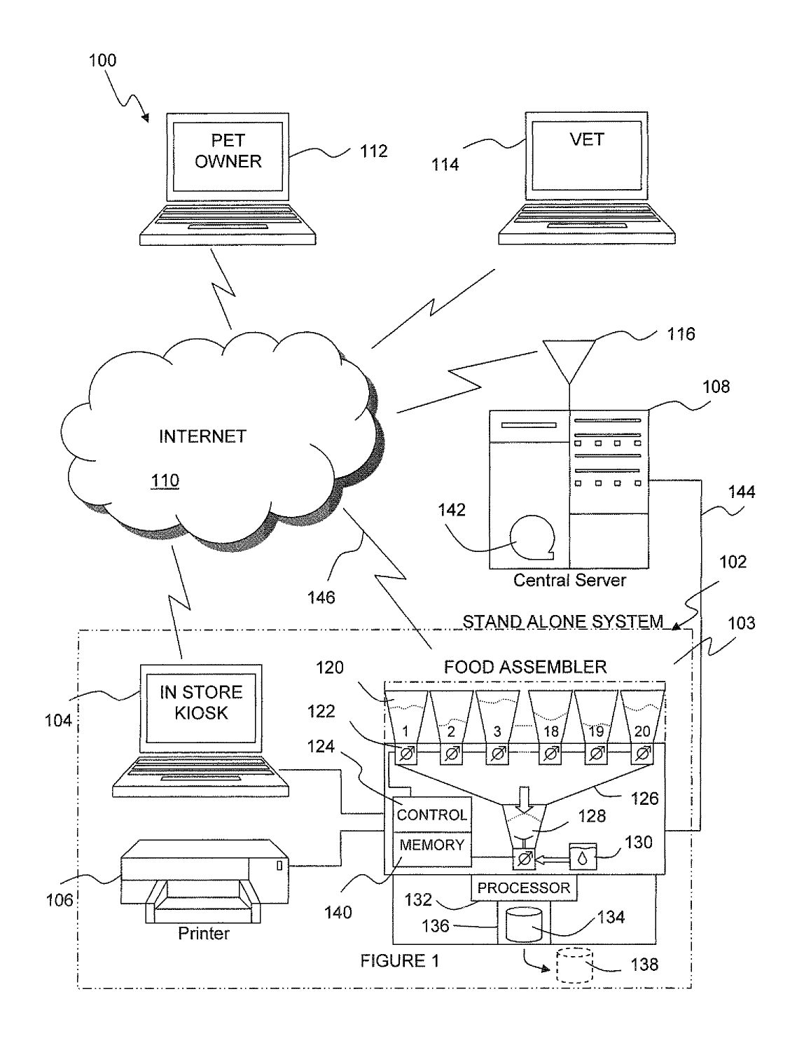

Referring initially to FIG. 1, a system level diagram of the apparatus for producing customized food blends for animals is shown and generally designated 100. System 100 includes a stand-alone system 102 having a food assembler 103 in communication with a kiosk terminal 104 and printer 106. A remotely located server 108 is in communication with the stand-alone system 102 and the Internet 110, with a number of remote user terminals, such as pet owner terminal 112 and veterinary terminal 114.

In operation, the devices within system 100 can communicate using communication methods known in the art. For instance, stand alone system 102 may communicate with central server 108, pet owner terminal 112 and/or veterinary terminal 114 via Internet 110. Alternatively, or in combination therewith, each of these devices may communicate over a network connection 144.

Stand alone system 102 includes the food assembler 103 that includes an array of food ingredient hoppers 120. Each food hopper (1, 2, 3 . . . 18, 19, 20) is filled with a different FDA approved food ingredient, including meats, vegetables, fruits, vitamins, minerals, medications, etc. It is to be appreciated that the present invention is not limited by the number of hoppers, or the content within the hoppers.

Each hopper 120 includes a metering flow valve 122 that provides for the selective activation and measurement of a particular food ingredient. For instance, 6 ounces of ingredient within hopper no. 1 can be dispensed, and 24 ounces of the ingredient within hoppers 2, 3, and 19, can be dispensed in accordance with instructions from controller 124. Controller 124 may, in a preferred embodiment, be any digital processing unit known in the industry, including but not limited to a microcontroller, a microprocessor, a reduced instruction set computer (RISC), a programmable logic device (PLD).

Once dispensed, food ingredients fall into a collection chute 126 and into a mixer 128. Once all ingredients have been dispensed from hoppers 120, mixer 128 then mixes the dispensed ingredients into a homogeneous mixture. In a preferred embodiment, ingredients within hoppers 120 are dry, such as dried fruits, vegetables, meats, powdered minerals, vitamins and medications. This provides for an ease in dispensing the ingredients by controller 124, and also provides for easier storage and a longer shelf-life of the base ingredients. In a particular embodiment, it may be advantageous to re-hydrate the mixed food ingredients by activating hydrator 130 to introduce fluid into the mixture.

Once the mixture is complete, processor 140 processes the mixed food ingredients into the final product form, such as muesli, kibble, powder, etc., to be dispensed into container 134 in dispensing chamber 136. Once the food product is dispensed into the container 134, it may be removed and delivered to the customer as shown by dashed lines 138.

In use of the stand alone system 102, a user approaches the in store kiosk terminal 104 and enters in specific customer data concerning the customer, customers animal(s), and their particular dietary and health needs. Through this interface, the user would be provided a recommended diet for the animal, and from that recommendation, selects the preferred ingredients for the food product. Once selected, the user then selects the size of the order (pounds), the delivery method, and completes the payment transaction.

Once the ingredient selection process, order and pickup information is completed, the listing of preferred ingredients, receipt, etc. may be output to printer 106. The in store kiosk terminal 104 is in communication with the food assembler 103 for identifying and transmitting the customer's food specifications to the food assembler 103 and controller 124 then initiates the assembly of the food product by selectively activating valves 122 on hoppers 120 to dispense the appropriate volume of each food ingredient.

In other uses, a remote terminal, such as pet owner terminal 112 or veterinary terminal 114 may be used to create the customer order as if using the in store kiosk 104. It is to be appreciated that the arrangement of the various devices within the system 100 as shown in FIG. 1 is merely exemplary of a preferred embodiment. The particular location of any device may be changed from what has been described without departing from the present invention. In fact, it is contemplated that the present invention is capable of being implemented in a variety of configurations, such as the food assembler 103 being located apart from the in store kiosk 104 and printer 106, or collocated with the central server 108. Further, a radio frequency link 116 may be incorporated into the devices in system 100 to provide yet another method of digital communication.

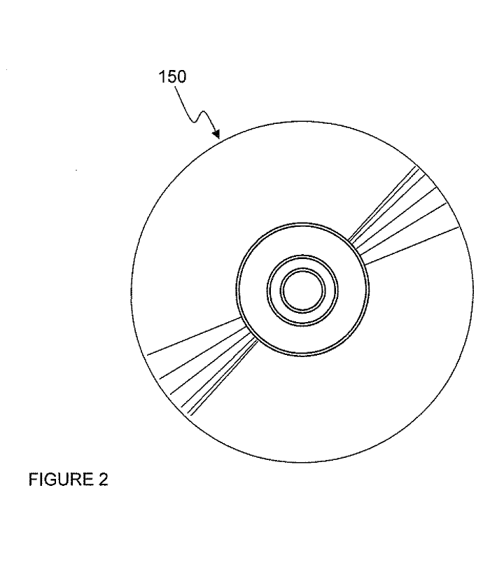

Referring to FIG. 2, a top plan view of an exemplary digital storage media is shown and generally designated 150. Digital storage media 150, in a preferred embodiment, is an optically-readable media upon which the method for producing customized food blends for animals can be stored and transmitted. It is to be fully contemplated that other digital storage media may be used without departing from the present invention, including but not limited to random access memory (RAM), read only memory (ROM), erasable programmable read only memory (EPROM), and any other media known in the art.

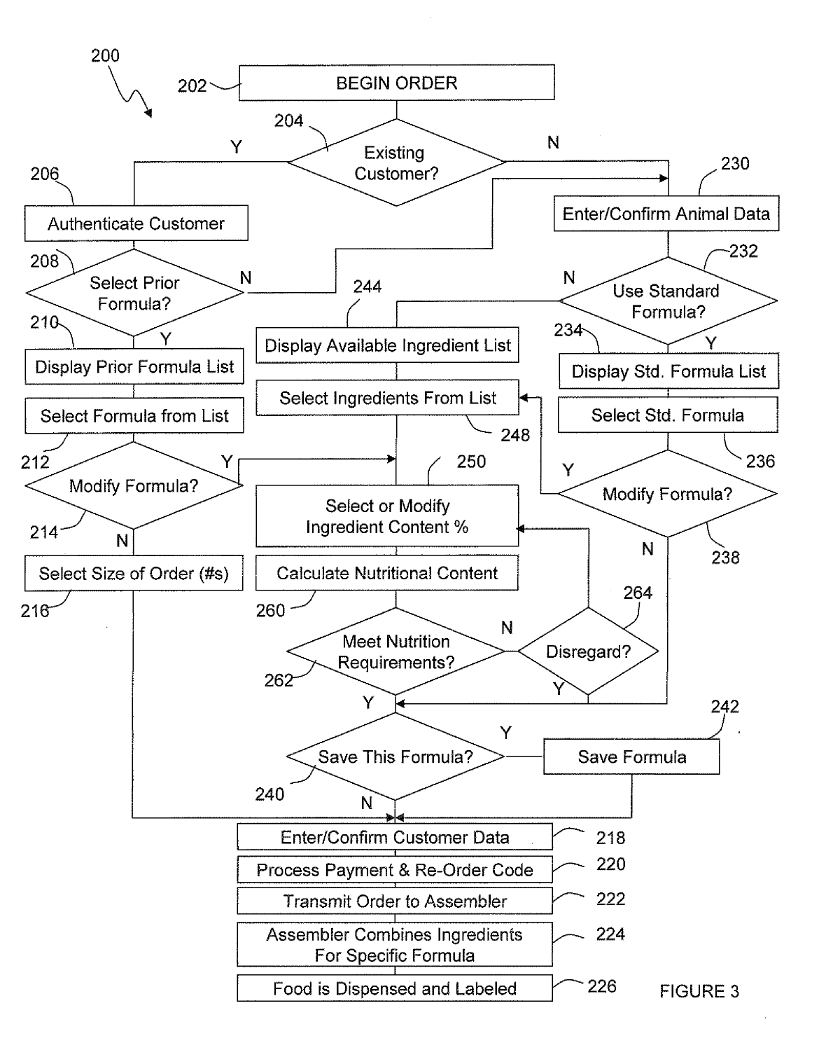

FIG. 3 is a flow chart of the method and apparatus for producing customized food blends for animals and is generally designated 200. Method 200 begins the order process in step 202 and identifies whether an existing customer is making the order in step 204. If the customer is an existing customer, method 200 continues to step 206 where the customer is authenticated, such as the entering of a unique customer password.

Once authenticated in step 206, the customer selects in step 208 whether to utilize a previously stored formula. If the customer wishes to use a previously stored formula, all prior formulae are displayed for the customer in step 210. The customer selects the appropriate formula from the list in step 212, and is given the opportunity to modify the prior formula in step 214. If no changes are made, the customer selects the size of the order, such as number of pounds or ounces; in step 216. The customer then confirms the customer data in step 218, processes payment and obtains an order code in step 220 to complete the order. The order is then transmitted to the assembler in step 222 which, in accordance with the discussion above, combines the specific food ingredients to make the particular food product in step 224. The food is dispensed and labeled in step 226.

In some circumstances, a customer may choose in step 208 to create a new formula, perhaps for a change in diet for an animal, or to order a new food product for an additional animal. In such circumstances, method 200 directs the customer to select and create a new product profile. Similarly, if a customer wishes to utilize a prior formula as a starting point, the customer may choose to modify the formula in step 214. In these circumstances, the customer will be directed to additional selection processes where the animal characteristics and food ingredients may be changed or modified.

When a customer uses the method and apparatus for producing customized food blends for animals for the first time, they choose the new customer option in step 204 which directs them to step 230 where they will enter relevant animal data. In a preferred embodiment, relevant animal data can include, but not be limited to, name, age, breed, or combinations of breeds, weight, underlying health conditions or ailments, allergies, food preferences, special nutritional requirements based on age, pregnancy, lactating, etc.

In situations where the customer's animal is typical for its age, health, etc., the customer may select in step 232 to use a standard formula. In this case, a standard formula list is displayed in step 234, and the customer selects from the standard formula list in step 236. In some cases, the customer will choose to not to modify the standard formula in step 238, thereby accepting the standard formula for the animal. The customer can then choose to save this formula in step 240 which will be saved in step 242.

Once saved, the customer then confirms the customer data in step 218, processes payment and obtains an order code in step 220 to complete the order. The order is then transmitted to the assembler in step 222 which, in accordance with the discussion above, combines the specific food ingredients to make the particular food product in step 224. The food is dispensed and labeled in step 226.

In situations where the customer chooses in step 232 not to use a standard formula, an available ingredient list is displayed in step 244 for the customer to review. The customer then selects in step 248 various food ingredients from the available ingredient list. Once these items are selected, the customer then selects or modifies the ingredient content percentages in step 250. In some cases, method 200 may present in step 250 some initial recommendations of ingredient percentages based on the AAFCO recommended nutritional requirements given the ingredients selected.

Once the customer has selected or modified the ingredient content in step 250, the nutritional content of the proposed food product is then calculated in step 260, and these calculations are then analyzed to verify that the animal's nutritional requirements will be met in step 262. If the nutritional requirements are not met, but the customer is determined to use this specific ingredient list and percentages selected, the customer can disregard the nutritional requirements in step 264, otherwise, the method returns to step 250 to select or modify the ingredients.

Once the customer is satisfied with the ingredient list and percentages, the customer can choose to save this formula to his or her customer profile in step 240, and the new formula is saved in step 242. The order for the food product is then finalized and produced in steps 218, 220, 222, 224, and 226 as described above.

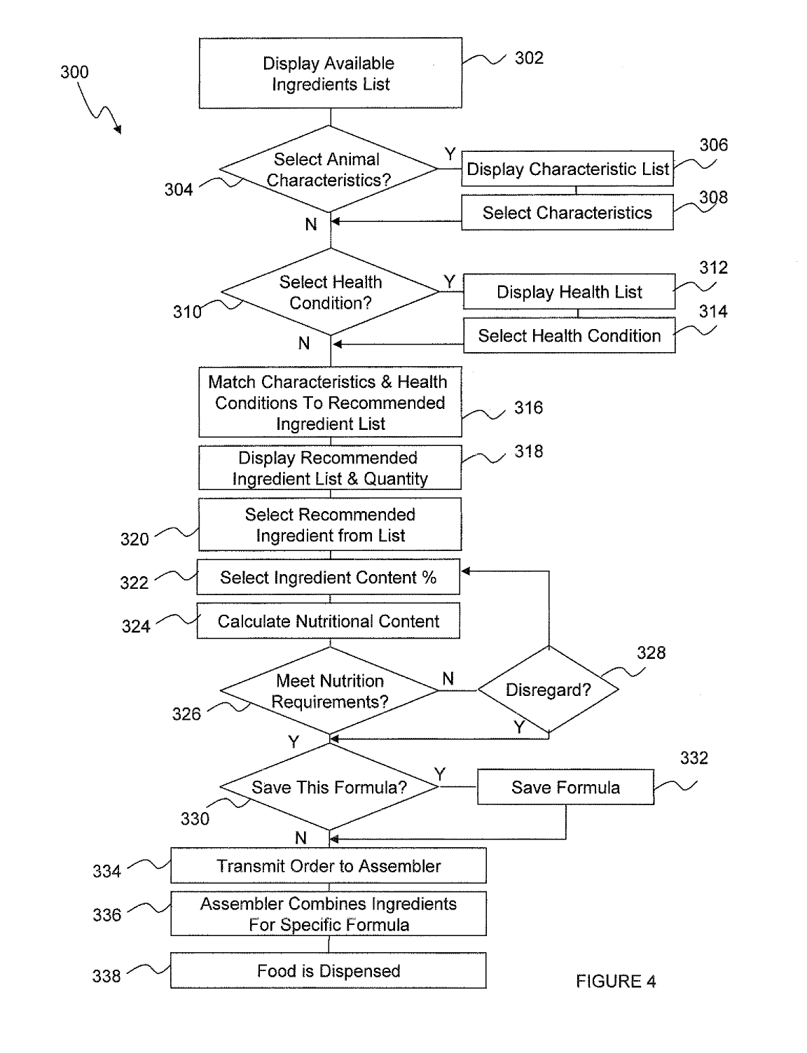

Referring now to FIG. 4, a flow chart of an alternative embodiment of the method for producing customized food blends for animals is shown and generally designated 300. Method 300 includes additional selection criteria for incorporation of animal characteristics and health conditions. Specifically, referring to FIG. 3, step 244 for reference, method 300 begins with step 302 in which the available ingredient list is displayed for the customer. In the following step 304, the customer chooses whether to select specific animal characteristics, or to rely on standard characteristics of the breed, weight and age as originally identified by the customer. If the customer chooses to select animal characteristics, those characteristics are displayed in step 306, and the customer selects the relevant characteristics in step 308.

The customer can also select specific health conditions related to the animal in step 310. In step 312 various health list items are displayed and the customer can select one or more of these health conditions in step 314. For instance, specific health conditions may include, but not be limited to, arthritis, allergies, heart disease, liver disease, diabetes, and the like. The present invention provides for the ‘filtering’ of ingredients based on specific health problems, organ issues, illness etc. to show recommended selections for certain situations that would guide people in what to select for their particular animals

Once animal characteristics and health conditions are specified, method 300 in step 316 matches the specified conditions with specific dietary requirements and corresponding ingredients on the ingredient list. In step 318, the recommended ingredient list and quantity are displayed, and the customer then selects from the recommendations in step 320. Once specific ingredients are selected, the customer in step 322 sets the specific content percentages for each ingredient. The nutritional content is then calculated in step 324 and compared in step 326 with nutritional requirements for the animal. These nutritional requirements may be standardized, such as from the AAFCO, and be stored in a look-up table within the server, or within the memory of the food assembler. Alternatively, a customer may customize the specific nutritional requirements for the animal.

If the nutritional requirements for the animal are not met, the customer may disregard this warning in step 328 and proceed to saving the formula in step 330, or the customer may return to step 322 to change the ingredient content percentages to correct any nutritional deficiency. In a preferred embodiment, the analysis performed in step 326 would identify any shortcomings or concerns regarding the specific ingredients of the proposed food product so that the customer could make informed changes in step 322, or understand the risks of disregarding the warnings in step 328.

Once the ingredient list is finalized, the customer may choose to save the formula in step 330, and the formula is saved in step 332. Next, the order is transmitted to the food assembler in step 324, the assembler combines the specified amount of the various ingredients in step 336, and the food is dispensed in step 338.

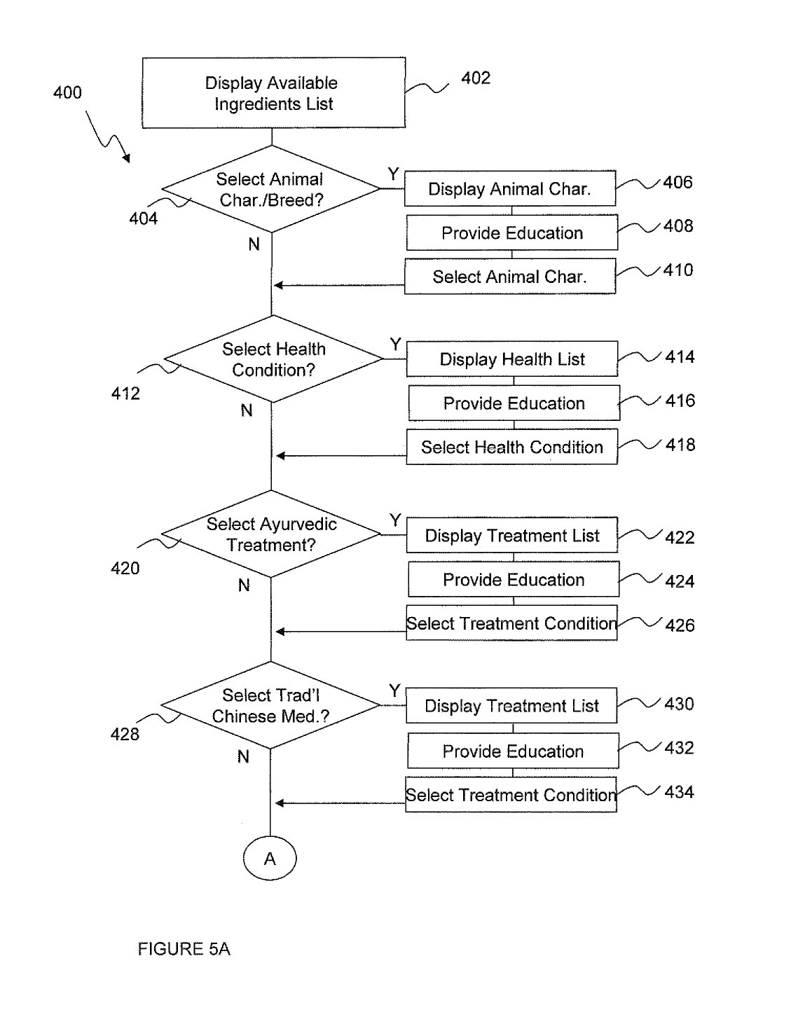

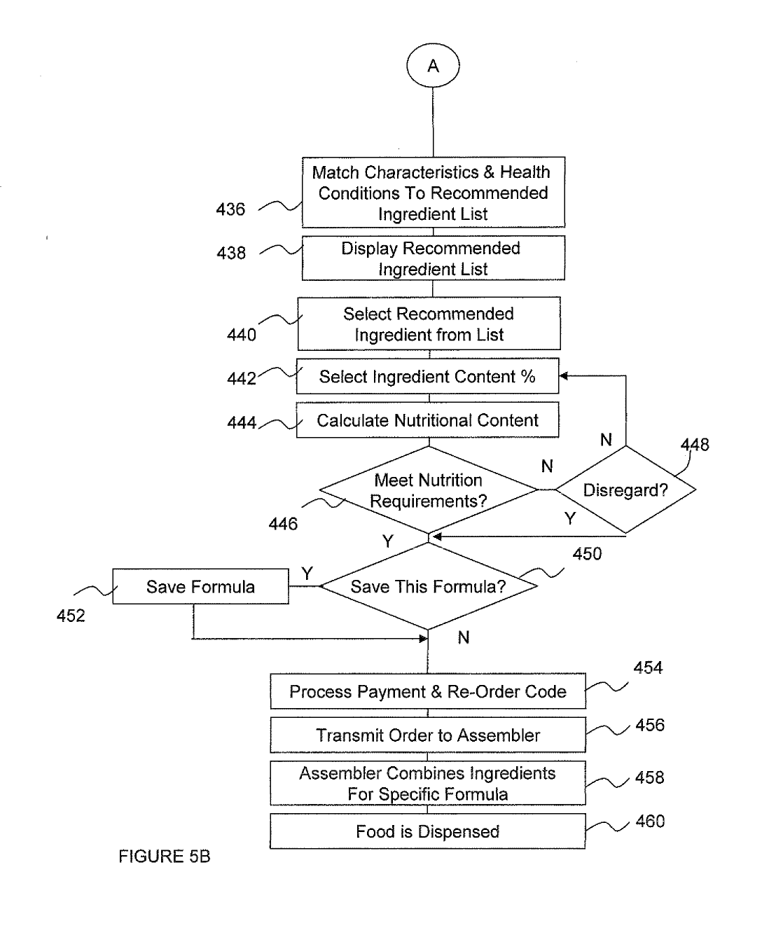

Referring now to FIGS. 5A and 5B, a flow chart of the method for producing customized food blends for animals is shown and generally designated 400. Method 400 includes steps for the recommendation and selection of ingredients based on a variety of animal-specific criterion. Specifically, method 400 starts in step 402 with the display of available ingredient list for the customer to review. This list is then further modified based on the responses to several animal-specific criteria. For instance, in step 404, the customer may choose to enter animal characteristics and breed. If chosen, animal characteristics are displayed in step 406, the customer is provided educational information in step 408 regarding these animal characteristics, and the customer chooses the animal characteristics relevant to the animal in step 410.

Further, in step 412, the customer may choose to enter animal health conditions. If chosen, a list of typical animal health issues is displayed in step 414, the customer is provided educational information in step 416 regarding these health issues, and the customer chooses the health issues relevant to the animal in step 418.

Similarly, in step 420, the customer may choose to select a number of ayurvedic health treatments. If chosen, a list of typical ayurvedic health treatments are displayed in step 422, the customer is provided educational information in step 424 regarding these ayurvedic treatments, and the customer chooses the ayurvedic treatments relevant to the animal in step 426.

In step 428, the customer may also choose to incorporate selected Traditional Chinese Medicine treatments. If chosen, a list of Typical Chinese Medical treatments are displayed in step 430, the customer is provided educational information in step 432 regarding these Chinese medical treatments, and the customer chooses the treatments relevant to the animal in step 434.

Once all treatments have been chosen through steps 404, 412, 420, and 428, method 400 accesses a database and matches the animal characteristics and health conditions to a recommended ingredient list in step 436. This recommended ingredient list is displayed in step 438 for the customer, and is intended to provide a baseline recommendation which satisfies the nutritional requirements of the animal, while simultaneously providing those treatments chosen through steps 404, 412, 420 and 428.

In step 440, the customer reviews the recommendations, selects various ingredients from the recommendations and in step 442, selects the ingredient content percentages. In some cases, recommendations will include the specific ingredients and content percentages based on historical or empirical data related to the various animal conditions. In other cases, only specific ingredients will be recommended without any specific percentage content if no recommendation data is available or recognized.

The nutritional content of the proposed food product is calculated in step 444, and those calculations are analyzed to ascertain whether the proposed food product meets the nutritional requirement of the animal. The customer may disregard any deficiencies in step 448, or can return to step 442 to change the ingredient content selections.

Once the formula is approved, the customer may choose to save this formula in step 450, and the formula is saved in step 452. The customer then processes payment and obtains an order code in step 454 to complete the order. The order is then transmitted to the assembler in step 456 which, in accordance with the discussion above, combines the specific food ingredients to make the particular food product in step 458. The food is dispensed and labeled in step 460.

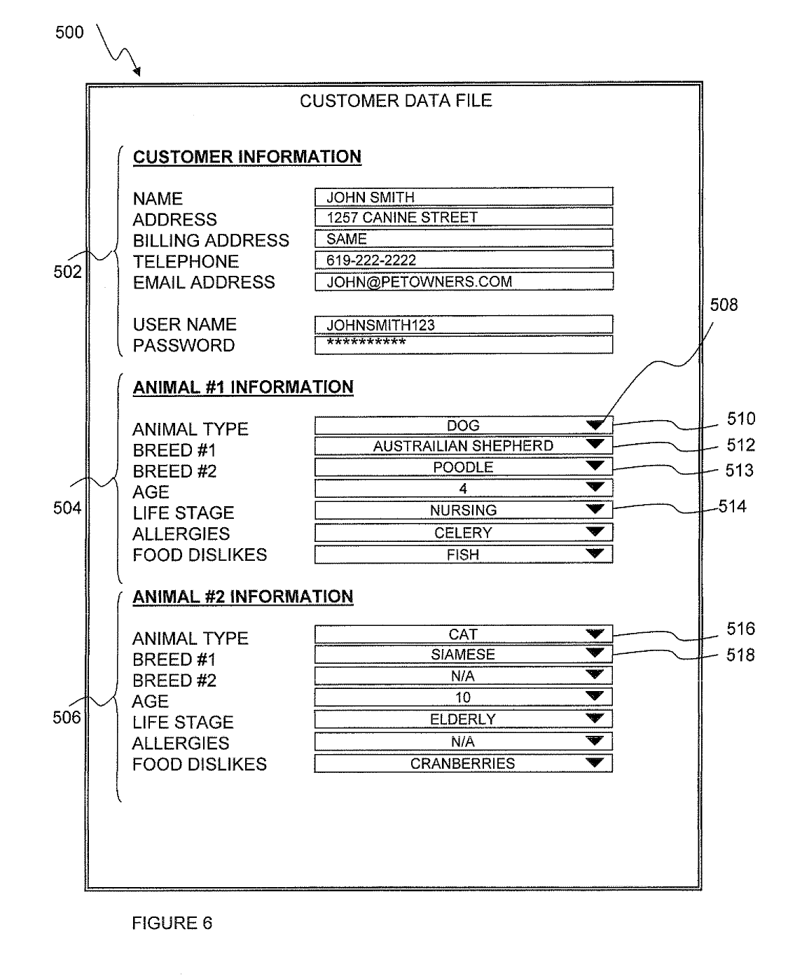

Referring now to FIG. 6, a representative view of an exemplary customer data file of the present invention is shown and generally designated 500. Data file 500 is typically stored in memory 140 or server memory 142, and includes customer information 502, including but not limited to, name, address, billing address, telephone number, email address, and a unique username and password. These data fields are fill-in type data fields requiring the customer to enter his or her customer information. Additionally, credit card payment information may also be entered and stored in the customer data file.

Also in data file 500 are data fields for a number of animals, such as Animal #1 information 504 and Animal #2 information 506. More specifically, referring to data field 504 for Animal #1, a pull-down menu icon 508 may be accessed to display a listing of supported animal types. For instance, dogs, cats, horses or other livestock such as cattle and sheep, rodents (hamsters, guinea pigs, rabbits, rats, mice), monkeys, among others may be listed within the animal type menu such that the customer may merely select one of the supported animal types as shown in field 510. Similarly, breed type #1 and if a hybrid, type #2, may be completed to indicate the breed of dog in fields 512 and 513. The age and life stage for the animal may also be completed by accessing the pull-down menus 514. For instance, in the life stage menu 514, there may be animal type specific stages, such as puppy, adult, pregnant, lactating(nursing), etc. for dogs. Also, known food allergies and food dislikes may be listed specifically from the pull-down menu.

Similar information may be used for Animal #2 data. In this instance, Animal #2 is a cat selected from the pull-down menu 516, and the breed is pure and Siamese 518. This particular animal is 10 years old, no known allergies, and dislikes cranberries.

While the exemplary data file as shown in FIG. 6 is typical of an embodiment of the present invention, the specific customer information, and information regarding that customer's animals, such as dog/cat, age, life stage, allergies, dislikes, etc. is merely exemplary and intended to disclose the versatility of the present invention in accommodating virtually all animal types, with virtually all types of age and health conditions.

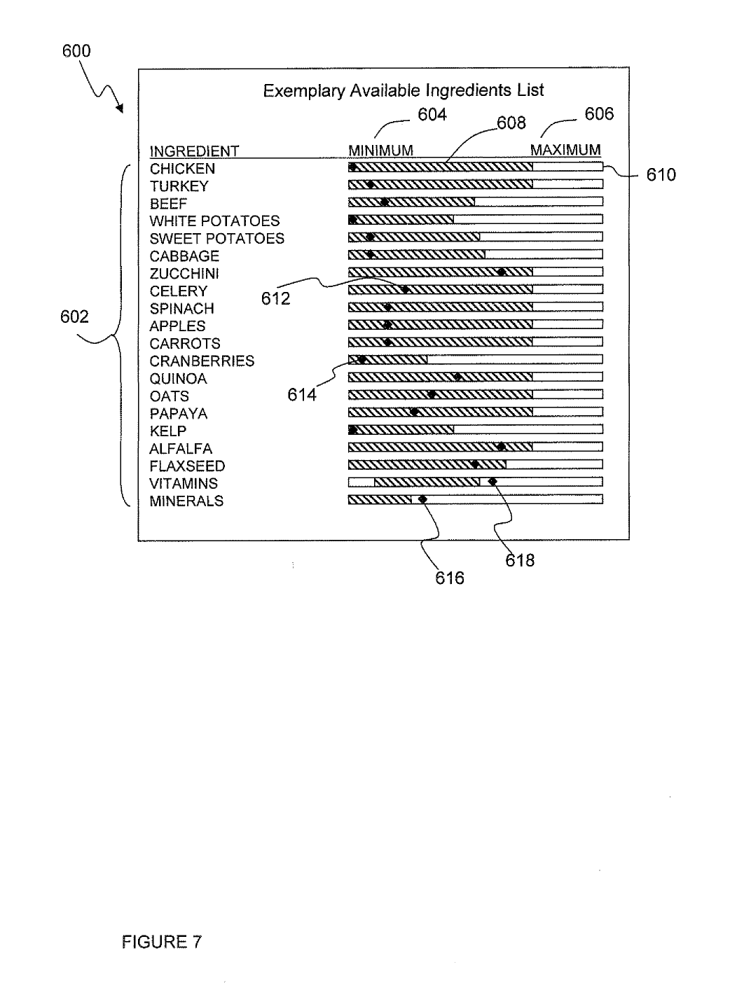

Referring to FIG. 7, a representative view of an exemplary available ingredient list of the present invention is shown and generally designated 600.

List 600 includes the specific ingredients 602 available within the food assembler 103 (shown in FIG. 1), and provides a graphical representation of the recommended minimum and maximum levels for each ingredient. For instance, a minimum level 604 and a maximum level 606 is provided by showing a cross-hatched box 608 within a 0-100 percent range 610.

The specific recommendations for minimums 604 and maximums 606 can be provided from AAFCO documentation, veterinary recommendations, or other standards known in the industry. In fact, these recommendations may indeed change from time to time as new and informative studies are completed thereby providing additional information to the industry. These updated recommended values can be stored in memory 140 or 142.

The customer may position a selection cursor, such as 612, 614, 616 and 618 within the ingredient range. These amounts of the ingredient based on percentage will be incorporated into the food product. As seen in this Figure, cursors 612 and 614, are positioned within the recommended levels; however, cursors 616 and 618 have been set above the recommended maximum levels. Since each animal is different and has its own specific health and medical issues, the flexibility to operate outside the recommended ingredient levels provides a customer the ability to select the ingredients that he or she knows works best for the animal.

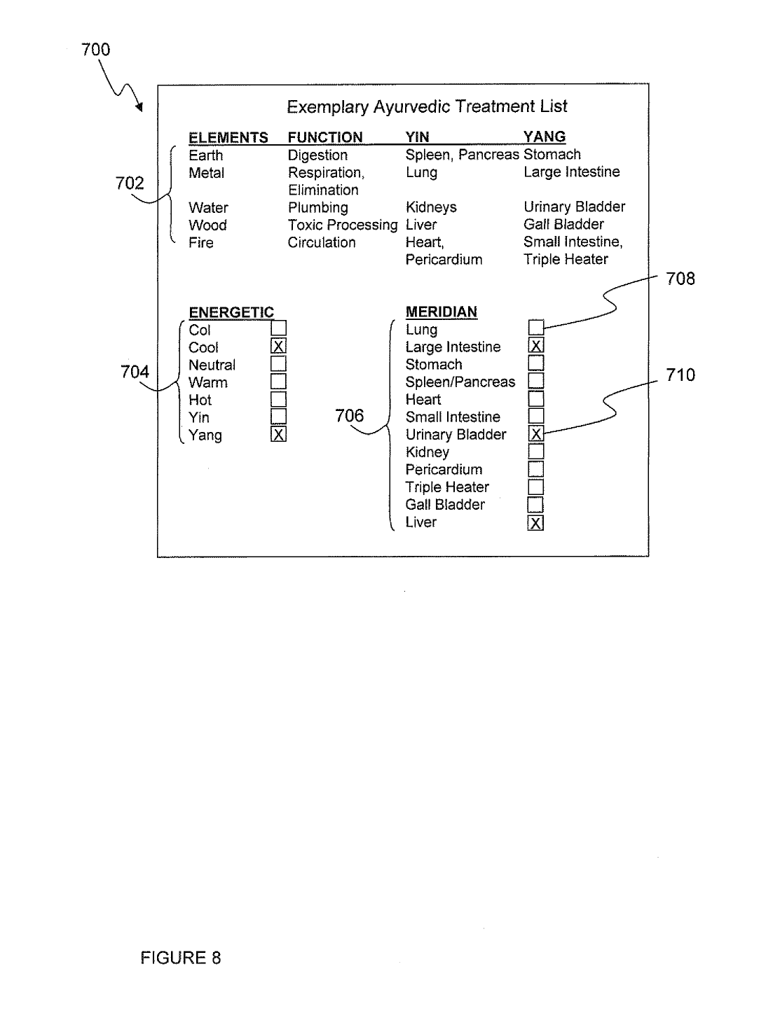

Referring now to FIG. 8, a representative view of an exemplary available list of ayurvedic treatments of the present invention is shown and generally designated 700. The ayurvedic treatment list includes the various elements 702 from which specific food ingredients may be added into the formula to address specific ayurvedic treatment requirements. Various energetic components 704 and dosha options 706 may be selected by the customer, such as by placing selection markers 710 in selection boxes 708.

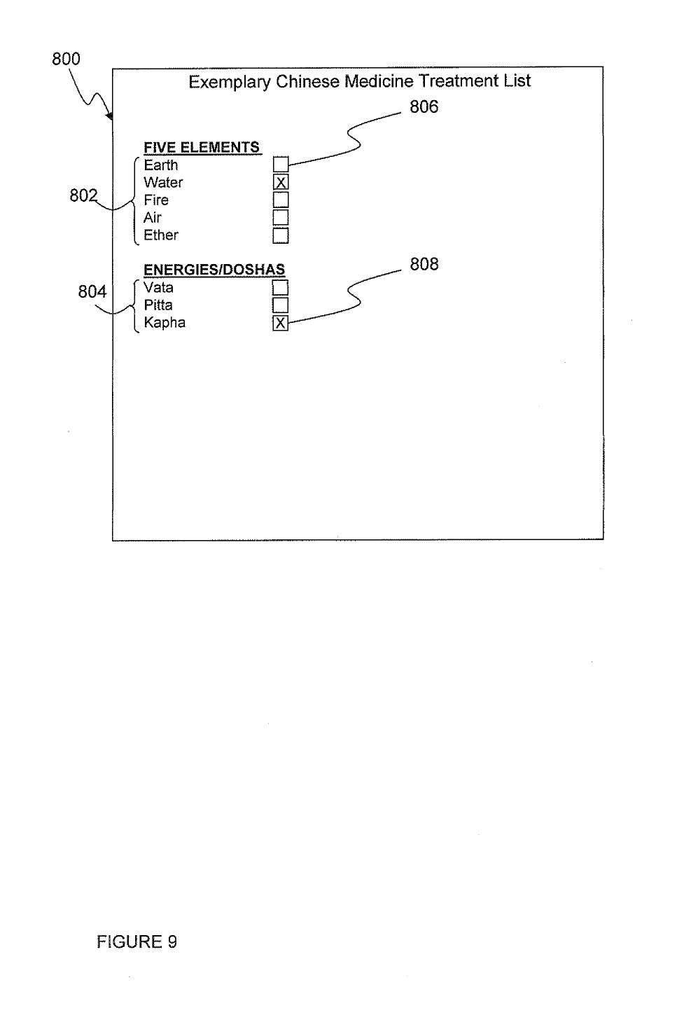

Similarly, in FIG. 9 is a representative view of an exemplary Traditional Chinese Medicine (TCM) treatment list of the present invention generally designated 800. List 800 includes the five basic Traditional Chinese Medicine treatment areas 802, including earth, water, fire, air and ether. Also, a selection of energetics and meridians 804 are provide so that the customer can select one or more elements or energies for incorporation into the formula to address specific Traditional Chinese Medicine treatment requirements, by placing a selection marker 808 in the corresponding selection box 810.

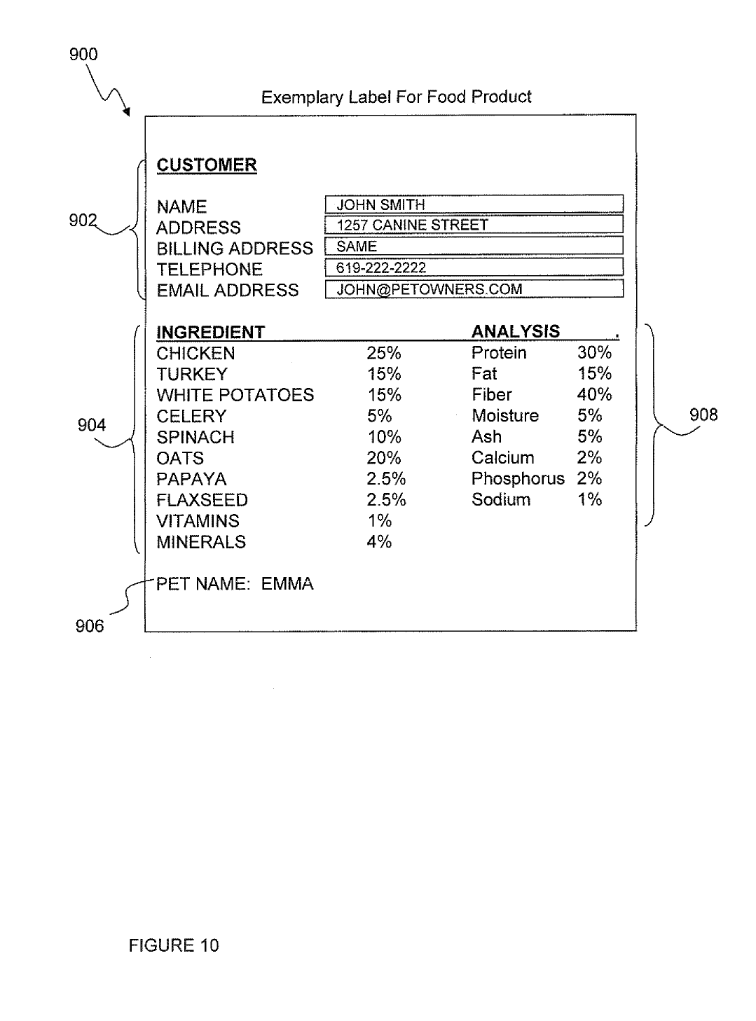

Referring to FIG. 10, a representative view of an exemplary label for the custom food product of the method and apparatus for producing customized food blends for animals is shown and generally designated 900. Label 900 includes the pertinent customer information 902 and pet identifier 906, an ingredient list 904 along with the percentage of each ingredient in the final food product and a proximate analysis 908 (percentage of protein, fat, fiber, moisture and ash, etc.) for the custom recipe. This label is merely intended as an exemplar of a preferred embodiment of the present invention and is not intended to limit the scope of the present invention.

### Alternative Embodiments

A method and apparatus for producing customized food blends for animals of the present invention provides a mechanism and system by which companion animal guardians and their veterinarians can create their own, customized recipes from a selection of ingredient choices, to meet the specific nutritional or medicinal needs of their pets.

As part of the customer interface, a customized web program that offers a selection of ingredients, parameters for percentages of total formulation, plus a running proximate analysis (protein, fat, fiber, moisture, ash) and other nutrients (calcium, phosphorus, sodium) according to the percentage of each ingredient chosen is provided herein. The method as described herein are intended to be implemented within a computer system such as the stand alone embodiment, or it can be web-based utilizing a distributed computer network to accomplish the specific method described herein. Utilizing this topology, the manufacturing of a commercial custom pet food preparation or blending of a bespoke blend of dehydrated foods according to customer or veterinarian derived recipes is fully contemplated.

In a facility-based embodiment, the blending of a variation of the ingredients according to the customer's recipe and baking it, or the blending of a variation of the ingredients according to the customer's recipe can be accomplished. The blending of a variation of the ingredients according to the customer's recipe and turning it into a fine power is also fully contemplated herein. The blending of ingredients according to the customer's recipe and packing it as a topper for, or additive to, commercial kibble is also fully contemplated herein.

Also, the blending of ingredients according to the customer's recipe and re-packing as an individual meal is fully contemplated herein. Blending the ingredients according to the customer's recipe and processing it into a kibble or canned (conventional style) animal food product is fully contemplated herein. Also, creating a batch of kibble or canned food according to a customer's recipe is fully contemplated herein.

In a retail-based embodiment, a customer may utilize the digital processing apparatus described herein to determine the optimum ingredients and percentage of each ingredient for their specific pet, and then pick the various ingredients, place it in a mixer/blender/grinder/spinner and assemble the food product within the store or at a factory. Alternatively, based on the same optimum ingredients and percentage of each ingredient, a customer may pick the various ingredients, place them in a mixer/blender/grinder/spinner and it assembles it for the customer. Also, the customer may utilize the digital processing apparatus disclosed herein to determine optimum ingredients, select the bulk food ingredients, and take ingredients home to mix for feeding.

In an “at home” embodiment, a customer may utilize the digital processing apparatus to determine the optimum ingredients for a particular animal, obtain the raw ingredients and mix those ingredients at home. As an alternative, home users may be provided a mini-version of the factory based hoppers for breeders or other home use, which allows the customer to program in a different recipe combination and have it blended fresh each day, to provide a slightly different combination selected from the possible set of ingredients. This can provide a slight dietary variation for each day of the week, or may provide a customer the ability to “fine-tune” an animal's diet in an attempt to address specific health concerns.

In each of the embodiments described herein, the re-hydration of dehydrated components is fully contemplated. As shown in FIG. 1, a hydrator 130 may be provided which introduces moisture into the food product to rehydrate any dry food components.

Other commercial embodiments could include but are not limited to production of the customized food formulation as a canned or pouched, ‘wet food’; baked or extruded as a kibbled dry-food product, or molded into an energy bar type format.

A significant advantage to the method and apparatus for producing customized food blends for animals of the present invention is that the customer can create their own recipe based on their pet's needs, or their veterinarian's recommendations. Also, a veterinarian can also create their own blend, as can retail stores, and can provide a service for veterinarians to ‘formulate’ their own recipes based on patients' specific needs.

The present invention allows the customer to select a percentage for each ingredient from within a designated recommended range (e.g. 0% to 80% for chicken, 0% to 15% for celery). Once the food product is assembled in accordance with the customer's requirements, the packaged food will be printed with the pet's name to make it completely personalized, as well as a customized ingredient and nutritional label. Once a particular formula is “perfected” by the customer, the present invention provides the customer with the capability to ‘repeat last order’ if they want to, rather than having to re-create their recipe every time.

For the present invention, the food ingredients are individually dehydrated and then blended together in appropriate amounts according to the custom recipe. By assembling dehydrated food ingredients, the mixing is more consistent, the storage is less troublesome because the shelf life is longer for dried goods, and when transporting the custom food products, the weight is less for dehydrated food due to lack of water weight in the product.

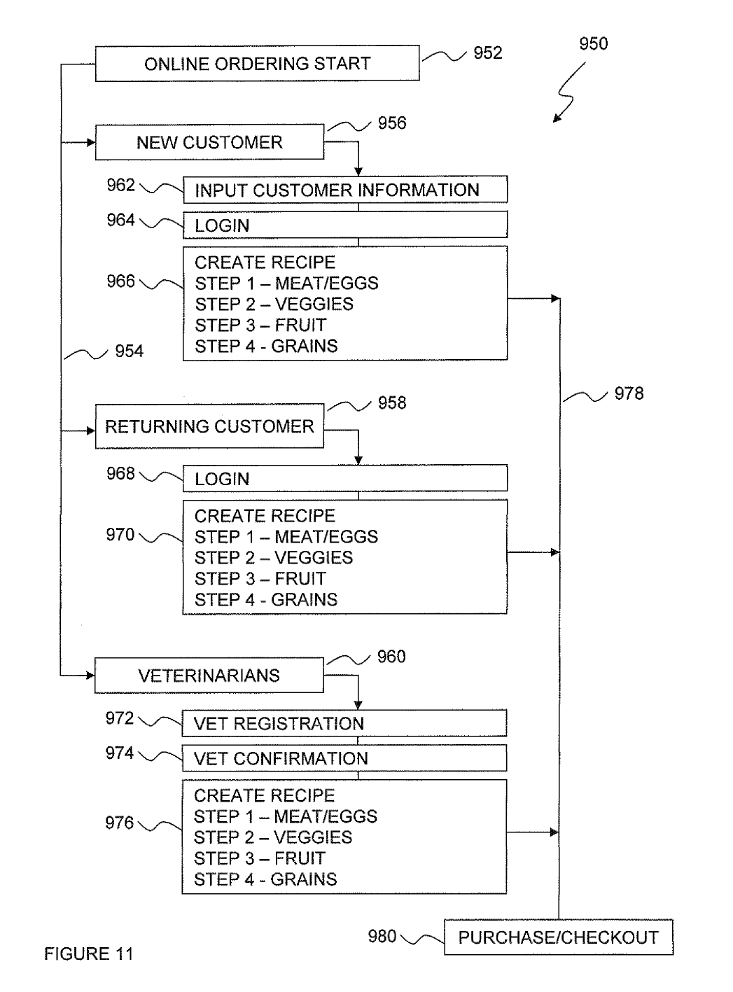

Referring now to FIG. 11, a flow chart of the method of the online user interface of the present invention is shown and generally designated 950. Method 950 begins in step 952 with the “online ordering state”, and proceeds to branch 954 where the user selects between a new customer in step 956, a returning customer in step 958, or a professional, such as a veterinarian in step 960.

Selection the “new customer” selection in step 956 provides for the input of customer information in step 962. Once the customer information is loaded, the customer is then logged in through step 964. Once logged in, the customer creates the recipe for the food blend in step 966. Recipe creation 966 includes a first step of selecting meat and/or eggs, a second step of selecting vegetables, a third step of selecting fruits, and a fourth step of selecting grains. Once the recipe creation is completed in step 966, method 950 advances to return branch 978 for purchase and checkout in step 980.

Selection of the “returning customer” selection in step 958 provides for the customer to log in through step 968. Once logged in, the customer creates the recipe for the food blend in step 970. Recipe creation 970 includes a first step of selecting meat and/or eggs, a second step of selecting vegetables, a third step of selecting fruits, and a fourth step of selecting grains. Once the recipe creation is completed in step 970, method 950 advances to return branch 978 for purchase and checkout in step 980.

Selection of the “professional selection” in step 960 provides for the registration of the professional, such as a veterinarian, in step 972. Once registered, the professional qualifications of the professional are verified instep 974, and the professional is confirmed. Once confirmed, in step 976 the professional creates the recipe for the food blend in step 976. Recipe creation 976 includes a first step of selecting meat and/or eggs, a second step of selecting vegetables, a third step of selecting fruits, and a fourth step of selecting grains. Once the recipe creation is completed in step 976, method 950 advances to return branch 978 for purchase and checkout in step 980.

In step 980, the user simply selects the quantity of the food blend to be purchased, identifies any delivery and pricing options, and pays for the products using an online payment mechanism that is well known in the art. Using the online user interface of the present invention provides remote users, such as pet owners located away from food manufacturing faculties, to create their own recipes and order quantities of custom blended pet foods that can be shipped directly to the user.

While there have been shown what are presently considered to be preferred embodiments of the present invention, it will be apparent to those skilled in the art that various changes and modifications can be made herein without departing from the scope and spirit of the invention.

I claim:

1. An apparatus for producing customized food blends, comprising:
a food assembler;
a kiosk terminal equipped with a printer and in communication with said food assembler;
a remotely located server in communication with said kiosk terminal; and
a plurality of remote user terminals in communication with said remotely located server.

2. The apparatus for producing customized food blends of claim 1, wherein said food assembler comprises an array of food ingredient hoppers, each said hopper finable with a different food ingredient.

3. The apparatus for producing customized food blends of claim 2, wherein said food hoppers comprise one food selected from the group of foods (meats, vegetables, fruits, vitamins, minerals, medications).

4. The apparatus for producing customized food blends of claim 2 wherein each said hopper includes a metering flow valve that provides for the selective activation and measurement of a particular food ingredient within said hopper.

5. The apparatus for producing customized food blends of claim 4, further comprising a controller in communication with said metering flow valve, and said metering flow valve responsive to signals from said controller to control the dispensing of food from within said hopper.

6. The apparatus for producing customized food blends of claim 4, further comprising collection chute positioned beneath said hoppers to collect said food dispensed from said hoppers.

7. The apparatus for producing customized food blends of claim 6, further comprising a mixer, said mixer receiving said food from said collection chute and mixes said dispensed food into a homogeneous mixture

8. The apparatus for producing customized food blends of claim 2, wherein said food within said hoppers is dry.

9. The apparatus for producing customized food blends of claim 8, further comprising a hydrator in communication with said mixer to hydrate said food blend within said mixer.

10. A method of producing customized food blends for animals, comprising the steps of:
displaying available ingredient list for the customer to review;
entering animal characteristics and breed;
entering animal health conditions;
selecting one or more ayurvedic health treatments;
selecting one or more Traditional Chinese Medicine treatments;
accessing database
matching the animal characteristics and health conditions to a recommended ingredient list;
displaying recommended ingredient list;
reviewing the recommended ingredient list;
selecting various ingredients from the recommendations;
selecting the ingredient content percentages;
calculating the nutritional content of the proposed food product;
analyzing nutritional content to ascertain whether the proposed food product meets the nutritional requirement of the animal; and
saving this food product formula.
